(19) United States
(12) Patent Application Publication
(10) Pub. No.: US 2024/0217454 A1
(43) Pub. Date: Jul. 4, 2024

(54) INTERIOR MEMBER-EQUIPPED ROOF MODULE, ROOF MODULE, AND METHOD OF MANUFACTURING INTERIOR MEMBER-EQUIPPED ROOF MODULE

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Kosuke SONE, Osaka (JP); Takuya TANIGUCHI, Osaka (JP); Ai TAKEHISA, Osaka (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 18/289,005

(22) PCT Filed: May 2, 2022
(86) PCT No.: PCT/JP2022/019501

§ 371 Date: Oct. 31, 2023

(30) Foreign Application Priority Data
May 21, 2021 (JP) 2021-086230

(51) Int. Cl. B60R 13/02; B60R 16/03

(52) U.S. Cl. CPC B60R 13/0212; B60R 16/03; B60R 13/0206

(57) ABSTRACT

A roof interior member is a roof interior member covering a roof panel of a vehicle from a side of a vehicle interior and including a plurality of segmented roof interior members, wherein the plurality of segmented roof interior members form a continuous body continuously formed in a state of extending in different regions in the roof panel to have a shape of covering the roof panel from the side of the vehicle interior.

### TECHNICAL FIELD

The present disclosure relates to a roof interior member, an interior member-equipped roof module, a roof module, and a method for manufacturing an interior member-equipped roof module.

### BACKGROUND ART

Patent Document 1 discloses a configuration that a wire harness assembly body formed into a plate-like shape is disposed between a ceiling and a roof liner.

### PRIOR ART DOCUMENTS

### Patent Document(s)

Patent Document 1: Japanese Patent Application Laid-Open No. 2018-90229

### SUMMARY

### Problem to be Solved by the Invention

In a technique disclosed in Patent Document 1, the roof liner needs to be detached in a maintenance operation of exchanging a transmission member or a roof-side apparatus disposed between the ceiling and the roof liner. The roof liner extends over the whole ceiling, thus there is a problem that the operation of detaching the roof liner is hard and maintenance properties are inefficient.

Accordingly, an object of the present disclosure is to improve maintenance properties of a transmission member or a roof-side apparatus disposed between a roof panel and a roof interior member.

### Means to Solve the Problem

A roof interior member according to the present disclosure is a roof interior member covering a roof panel of a vehicle from a side of a vehicle interior and including a plurality of segmented roof interior members, wherein the plurality of segmented roof interior members form a continuous body continuously formed in a state of extending in different regions in the roof panel to have a shape of covering the roof panel from the side of the vehicle interior.

An interior member-equipped roof module according to the present disclosure includes: the roof interior member described above; and an intermediate support member which can be attached to the roof panel, wherein at least one of the plurality of segmented roof interior members is supported by the roof panel via the intermediate support member.

A roof module according to the present disclosure is a roof module including: an intermediate support member disposed on a side of a vehicle interior of a roof panel of a vehicle; and a roof component disposed between the roof panel and the roof interior member, wherein the roof component is at least one of a roof-side apparatus and/or a transmission member, the intermediate support member directly or indirectly supports the roof component, and the intermediate support member includes a panel-side fixing part fixed to the roof panel and an interior member-side fixing part to which the roof interior member is fixed.

A method of manufacturing an interior member-equipped roof module according to the present disclosure is a method of manufacturing an interior member-equipped roof module including: (a) preparing plural types of intermediate support members distinguished in accordance with presence or absence of support of a roof component and a type of the roof component which is supported; (b) selecting an intermediate support member, which is to be attached, from the plural types of intermediate support members in accordance with presence or absence and a type of a roof component disposed between a roof panel and a roof interior member; (c) attaching the intermediate support member which has been selected to the roof panel; and (d) attaching a roof interior member to the intermediate support member.

### Effects of the Invention

According to the present disclosure, maintenance properties of a transmission member or a roof-side apparatus disposed between a roof panel and a roof interior member can be improved.

### BRIEF DESCRIPTION OF DRAWINGS

FIG. 1 is a schematic perspective view illustrating an example of a vehicle into which a roof interior member according to an embodiment 1 is incorporated.

FIG. 2 is a perspective view illustrating an interior member-equipped roof module.

FIG. 3 is an exploded perspective view illustrating a roof module.

FIG. 4 is an exploded perspective view illustrating the roof interior member.

FIG. 5 is a drawing schematically illustrating an example of segmented roof interior members with edges overlapped with each other.

FIG. 6 is a drawing schematically illustrating another example of the segmented roof interior members with the edges overlapped with each other.

FIG. 7 is a schematic cross-sectional view illustrating a support structure of an intermediate support member and a roof interior member on a roof panel.

FIG. 8 is a perspective view illustrating a modification example according to a fixing part.

FIG. 9 is a perspective view illustrating a modification example according to the fixing part.

FIG. 10 is a schematic cross-sectional view illustrating a modification example according to the fixing part.

FIG. 11 is a perspective view illustrating another modification example according to the fixing part.

FIG. 12 is a schematic cross-sectional view illustrating another modification example according to the fixing part.

FIG. 13 is a schematic cross-sectional view illustrating a modification example of positioning the segmented roof interior member.

FIG. 14 is a perspective view illustrating an interior member-equipped roof module.

FIG. 15 is a perspective view illustrating a roof module.

FIG. 16 is a perspective view illustrating the roof module.

FIG. 17 is an explanation diagram illustrating a method of manufacturing an interior member-equipped roof module.

### DESCRIPTION OF EMBODIMENT(S)

### Description of Embodiment of Present Disclosure

Embodiments of the present disclosure are listed and described firstly.

A roof interior member according to the present disclosure is as follows.

(1) A roof interior member is a roof interior member covering a roof panel of a vehicle from a side of a vehicle interior and including a plurality of segmented roof interior members, wherein the plurality of segmented roof interior members form a continuous body continuously formed in a state of extending in different regions in the roof panel to have a shape of covering the roof panel from the side of the vehicle interior.

According to the roof interior member, some of the plurality of segmented roof interior members can be detached to perform maintenance of the transmission member or the roof-side apparatus disposed between the roof panel and the roof interior member. Thus, maintenance properties of the transmission member or the roof-side apparatus disposed between the roof panel and the roof interior member can be improved.

(2) In the roof interior member according to (1), edges of the plurality of segmented roof interior members may be overlapped with each other at a boundary. Accordingly, a gap between the segmented roof interior members can be suppressed.

An interior member-equipped roof module according to the present disclosure is as follows.

(3) An interior member-equipped roof module includes: the roof interior member according to (1) or (2); and at least one intermediate support member which can be attached to the roof panel, wherein at least one of the plurality of segmented roof interior members is supported by the roof panel via the intermediate support member. Accordingly, at least one of the segmented roof interior members is easily supported by the roof panel via the intermediate support member.

(4) In the interior member-equipped roof module according to (3), at least one of a roof-side apparatus and/or a transmission member disposed between the roof panel and the roof interior member may be directly or indirectly supported by the intermediate support member. Accordingly, the intermediate support member supports the segmented roof interior member and at least one of the roof-side apparatus and/or the transmission member.

(5) In the interior member-equipped roof module according to (3) or (4), a sheet-like member disposed between the roof panel and the roof interior member may be supported by the intermediate support member in a planarly extending form. In this case, the intermediate support member supports the sheet-like member in the planarly extending form, thus the sheet-like member is easily incorporated into the roof panel on a side of the vehicle interior.

(6) It is applicable that the interior member-equipped roof module according to any one of (3) to (5) includes a fixing part fixing the segmented roof interior members to the intermediate support member, wherein at least one of the segmented roof interior members and/or the intermediate support member includes a movable support part position-adjustably supporting the fixing part in a direction in which the segmented roof interior members extend. Accordingly, the fixing part is position-adjustably supported by the movable support part of at least one of the segmented roof interior members and/or the intermediate support member, thus an operation of fixing the segmented roof interior members to the intermediate support member can be easily performed.

(7) In the interior member-equipped roof module according to any one of (3) to (6), it is applicable that a positioning concave part is formed in one of the intermediate support member and the segmented roof interior members, and a positioning convex part fitted to the positioning concave part is formed in another one of the intermediate support member and the segmented roof interior members. Accordingly, the positioning concave part is fitted to the positioning convex part, thus the position of the roof interior member in relation to the intermediate support member is corrected.

(8) It is applicable that the interior member-equipped roof module according to any one of (3) to (7) includes the plurality of intermediate support members, wherein the boundary between the plurality of segmented roof interior members are located between the plurality of intermediate support members. Accordingly, an intermediate portion of the segmented roof interior members can be firmly supported by the intermediate support member.

A roof module according to the present disclosure is as follows.

(9) A roof module includes: an intermediate support member disposed on a side of a vehicle interior of a roof panel of a vehicle; and a roof component disposed between the roof panel and the roof interior member, wherein the roof component is at least one of a roof-side apparatus and/or a transmission member, the intermediate support member directly or indirectly supports the roof component, and the intermediate support member includes a panel-side fixing part fixed to the roof panel and an interior member-side fixing part to which the roof interior member is fixed.

Accordingly, the roof interior member can be supported by the intermediate support member directly or indirectly supporting the roof component. Accordingly, also achievable is a configuration appropriate to support the segmented roof interior member, and this configuration also leads to improvement of maintenance properties of the transmission member or the roof-side apparatus disposed between the roof panel and the roof interior member.

A method of manufacturing an interior member-equipped roof module according to the present disclosure is as follows.

(10) A method of manufacturing an interior member-equipped roof module includes: (a) preparing plural types of intermediate support members distinguished in accordance with presence or absence of support of a roof component and a type of the roof component which is supported; (b) selecting an intermediate support member, which is to be attached, from the plural types of intermediate support members in accordance with presence or absence and a type of a roof component disposed between a roof panel and a roof interior member; (c) attaching the intermediate support member which has been selected to the roof panel; and (d) attaching a roof interior member to the intermediate support member.

Accordingly, achievable is a configuration of supporting the roof interior member by the intermediate support member regardless of the presence or absence and the type of the roof component. Also achievable is a configuration appropriate to support the segmented roof interior member by the intermediate support member, and this configuration also leads to improvement of maintenance properties of the transmission member or the roof-side apparatus disposed between the roof panel and the roof interior member.

### Detailed Description of Embodiment of Present Disclosure

Specific examples of a roof interior member, an interior member-equipped roof module, a roof module, and a method of manufacturing an interior member-equipped roof module according to the present disclosure are described hereinafter with reference to the drawings. The present disclosure is not limited to these examples, but is indicated by claims, and it is intended that meanings equivalent to claims and all modifications within a scope of claims are included.

### Embodiment 1

A roof interior member, an interior member-equipped roof module, and a roof module according to an embodiment 1 are described hereinafter.

<Vehicle into which Roof Interior Member is Incorporated>

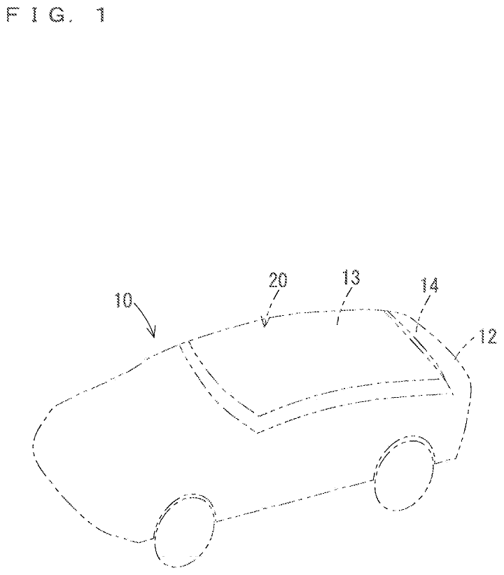

FIG. 1 is a schematic perspective view illustrating an example of a vehicle 10 into which a roof interior member is incorporated. This vehicle is also an example of a vehicle into which an interior member-equipped roof module and a roof module are incorporated.

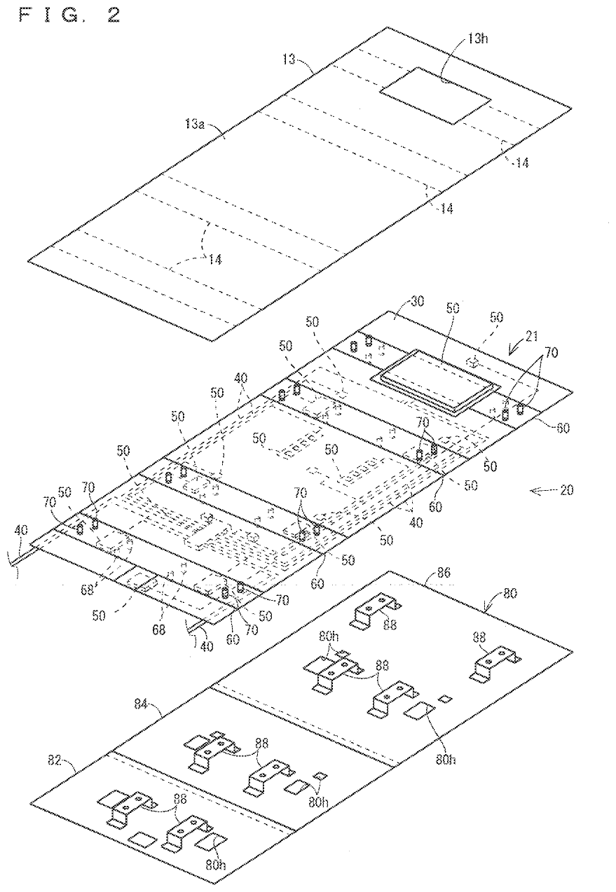

The vehicle 10 includes a body 12. The body 12 is a part forming an outer shape of the vehicle 10. The body 12 may be a monocoque body or a body mounted on a ladder type frame. Herein, the body 12 includes a lateral panel surrounding a vehicle interior, a roof panel 13, a boarding door panel for a passenger to get in or out of a vehicle, and a rear door panel to take in and out a luggage, for example. The body 12 may be formed by metal or resin. The body 12 may also be made of a combination of metal and resin. A plate-like part of the body 12 covering an upper side of the vehicle interior constitutes the roof panel 13. That is to say, the roof panel 13 forms a roof part of the vehicle 10. The roof panel 13 may be partially or wholly curved to form an appearance shape of the body 12. The roof panel 13 may be formed by metal or resin. The roof panel 13 may also be made of a combination of metal and resin. Herein, an antenna opening 13h is formed in the roof panel 13 (refer to FIG. 2).

FIG. 2 is a perspective view illustrating an interior member-equipped roof module 20. FIG. 2 illustrates the roof panel 13. A transmission member illustrated in FIG. 2 indicates a schematic route, thus there may be a case where the transmission member includes a plurality of transmission members even when it is illustrated as a single wire.

The roof panel 13 includes a roof reinforcement member 14. That is to say, the roof panel 13 includes a panel body 13a having a plate-like shape, and the roof reinforcement member 14 supports and reinforces the panel body 13a from a lower side. The roof reinforcement member 14 is a member referred to as a roof reinforcement or a roof stay, for example. In the present embodiment, the plurality of roof reinforcement members 14 are elongated members, and provided at intervals in a front-back direction of the roof panel 13. The roof reinforcement member 14 is disposed along a width direction of the panel body 13a. When the panel body 13a is made of metal, the roof reinforcement member 14 formed of metal may be welded to an inner surface of the panel body 13a. The roof reinforcement member 14 supports the interior member-equipped roof module 20. In this point, the roof reinforcement member 14 is also a type of a bracket supporting the other component.

In the present embodiment, the roof reinforcement member 14 is an example of an assembly target part to which the interior member-equipped roof module 20 is attached. In the present example, an intermediate support member 60 of the interior member-equipped roof module 20 is attached to the assembly target part.

### <Whole Structure of Interior Member-Equipped Roof Module>

As illustrated in FIG. 2, the interior member-equipped roof module 20 includes a roof interior member 80 and an intermediate support member 60.

The roof interior member 80 is provided to the lower side of the roof panel 13. The roof interior member 80 covers the roof panel 13 from a side of a vehicle interior. The roof interior member 80 is a plate-like member formed of resin, for example. The roof interior member 80 may be partially or wholly curved. The roof interior member 80 is attached to a lower side of the roof panel 13. The roof interior member 80 is exposed to the side of the vehicle interior to constitute a design of a ceiling viewed from an inner side of the vehicle. The roof interior member 80 may also be referred to as a roof liner.

A space is provided between the roof panel 13 and the roof interior member 80. The intermediate support member 60 is disposed the roof panel 13 and the roof interior member 80. The intermediate support member 60 is a member which can be attached to the roof panel 13. The roof interior member 80 is attached to the roof panel 13 via the intermediate support member 60.

In the present embodiment, the intermediate support member 60 is integrally combined with the roof component (the roof-side apparatus 50 and the transmission member 40, for example) to constitute a roof module 21. This roof module 21 is disposed between the roof panel 13 and the roof interior member 80. The combination of this roof module 21 and the roof interior member 80 constitutes the interior member-equipped roof module 20.

### <Roof Module>

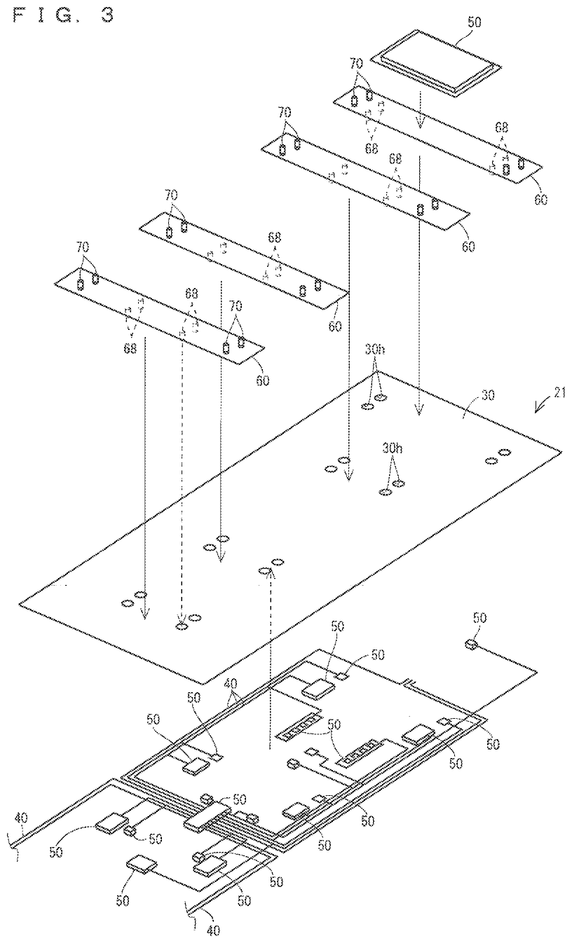

The roof module 21 is described more specifically. FIG. 3 is an exploded perspective view illustrating the roof module 21.

The roof module 21 includes the intermediate support member 60 and the roof component. The intermediate support member 60 is a member disposed to the side of the vehicle interior of the roof panel 13. The roof component is a component disposed between the roof panel 13 and the roof interior member 80. The roof component can be assumed to be at least one of the roof-side apparatus 50 and/or the transmission member 40. The intermediate support member 60 directly or indirectly supports the roof component. Described in the present embodiment is an example that the intermediate support member 60 indirectly supports the roof-side apparatus as the example of the roof component and the transmission member 40 via the sheet-like member 30. Thus, in the present embodiment, the roof module 21 includes the sheet-like member 30. The roof component may be directly supported by the intermediate support member 60, and an example in such a case is described in a subsequent embodiment 2.

The sheet-like member 30 is a sheet-like member planarly extending between the roof panel 13 and the roof interior member 80. For example, the sheet-like member 30 may be disposed to cover 80% or more of an area of the roof interior member 80. For example, the sheet-like member 30 may be disposed to extend over a whole upper side of head rests of a plurality of passenger seats in the vehicle. The sheet-like member 30 is disposed to extend on the roof interior member 80, thus the transmission member 40 can be supported in a region in the roof interior member 80 as large as possible. A function described hereinafter of the sheet-like member 30 can be performed on a region in the roof interior member 80 as large as possible.

The sheet-like member 30 may include a layer having at least one of a heat insulation function, an acoustic insulation function, and/or a radio wave shielding function. That is to say, the sheet-like member 30 may be a sheet having at least one of a heat insulation function, an acoustic insulation function, and a radio wave shielding function in addition to the function of holding the transmission member 40, for example.

For example, the sheet-like member 30 may include a non-woven layer. The non-woven layer is an example of a layer in which a plurality of fibers are not woven but are tangle and having heat insulation properties suppressing heat transmission between one main surface and the other main surface of the sheet-like member 30. The heat insulating layer may be a layer reflecting heat radiation energy. The heat insulating layer may be a layer having a lower thermal conductivity than the other layer. For example, a sheet including minute spaces such as a non-woven sheet or a foam sheet, for example, may be used for the heat insulating layer. A heat insulating coating or a heat shielding coating may be used as the heat insulating layer.

The non-woven layer can also be grasped as an example of a layer having acoustic insulation properties suppressing an acoustic transmission between one main surface and the other main surface of the sheet-like member 30. The layer having the acoustic insulating properties may reflect sound or absorb energy of sound as heat energy. For example, a sheet including minute spaces such as a non-woven sheet or a foam sheet, for example, may be used as an acoustic insulating layer. A sound absorbing coating may be used as the acoustic insulating layer.

The heat insulating layer and the acoustic insulating layer may be provided as physically different layers.

For example, the sheet-like member 30 may include a radio wave shielding layer. The radio wave shielding layer is a layer suppressing a radio wave transmission between one main surface and the other main surface of the sheet-like member 30. The radio wave shielding layer may have radio wave shielding properties on all of frequencies. The radio wave shielding layer may have selective radio wave shielding properties on some frequency band. In this case, it is sufficient that at least one of reflection and absorption of radio wave of some frequency band is performed in the radio wave shielding layer. The radio wave shielding layer may be a layer formed of a metal foil such as aluminum or iron. A known frequency selective surface (FSS) may be used as the radio wave shielding layer having the selective radio wave shielding properties. The frequency selective film may have a configuration that a unit cell (element) is formed by a metal foil on a base film formed of resin, for example. Such a frequency selective surface has characteristics of selectively shielding radio wave of one or a plurality of frequency bands in accordance with frequency characteristics of the unit cell (element), and passing radio wave of the other frequency band. The radio wave shielding layer having the selective radio wave shielding properties may also be formed by directly printing a conductive paste on a heat insulating layer or an acoustic insulation layer, for example.

When the sheet-like member 30 includes the radio wave shielding layer, an external communication antenna unit is preferably provided on an outer vehicle side of the radio wave shielding layer. Based on a premise that the sheet-like member 30 includes the radio wave shielding layer, an interior-side antenna is preferably provided on the side of the vehicle interior of the radio wave shielding layer. The interior-side antenna may be an antenna for radio communication with an interior apparatus or an antenna for non-contact power supply to the interior apparatus.

When the sheet-like member 30 includes a plurality of layers, the layers may be simply overlapped with each other. The layers may be fixed to each other by a double-sided tape, an adhesive agent, or welding, for example. An order of overlapping each layer is optionally set. For example, the radio wave shielding layer may be provided on the lower side of the non-woven layer. In a case where the sheet-like member includes a plurality of functional layers, it is not necessary to arrange the plurality of functional layers to be overlapped in a thickness direction of the sheet-like member. The plurality of functional layers may be provided in different regions in a region where the sheet-like member extends. For example, the plurality of functional layers may be provided side by side in a region where the sheet-like member extends. The other functional layer may be partially provided on one functional layer.

The transmission member 40 is a member transmitting electrical power or light, for example, and is a member in which at least one end thereof is provided along a wiring route connected to the roof-side apparatus 50. For example, the transmission member 40 may be a general wire having a core wire and a covering around the core wire, or may also be a bare conductive wire, a shielded wire, an electrical cable, an enamel wire, a nichrome wire, a coaxial wire, or an optical fiber. That is to say, the transmission member 40 may be a wire-like member transmitting electrical power. The wire-like member transmitting the electrical power may be various kinds of signal lines or various kinds of power lines. The wire-like member transmitting the electrical power may be a single wire-like object or a composite object of a plurality of wire-like objects (a twisted wire and a cable made up of a plurality of wire-like objects covered by a sheath, for example). The transmission member may be formed by applying a conductive coating on the sheet-like member and etching on a copper foil, for example. Description herein is based on an assumption that the transmission member 40 is an electrical wire.

The transmission member 40 is provided to the sheet-like member 30. Herein, a state where the transmission member 40 is provided the sheet-like member 30 indicates that a medium transmitting electrical power or light is formed to constitute an electrical or optical route on the sheet-like member. Thus, the transmission member 40 provided to the sheet-like member includes the transmission member directly formed by applying a conductive coating to the sheet-like member 30 and etching on a copper foil and the transmission member in which the wire-like transmission member 40 manufactured separately from the sheet-like member 30 is attached to form a constant route along one of or both main surfaces of the wire-like transmission member. A specific configuration for supporting the transmission member 40 is not particularly limited.

For example, the transmission member 40 may be fixed to one main surface of the sheet-like member 30. For example, the transmission member 40 may be welded to one main surface of the sheet-like member 30. A welding part thereby formed has a configuration that a part of at least one of the transmission member 40 and/or the sheet-like member 30 is melted and adheres to the other side member. The transmission member 40 and the sheet-like member 30 may be welded by ultrasonic welding or thermal welding. It is also applicable that a surface of at least one of the transmission member 40 and/or the sheet-like member 30 is melted by a solvent to weld the transmission member 40 and the sheet-like member 30. For example, the transmission member 40 may be fixed to the sheet-like member 30 by an adhesive agent or a double-sided tape, for example. For example, the transmission member 40 may be sewn to the sheet-like member 30 by a sewing thread, for example. It is also applicable that an adhesive tape is attached to a portion from an outer side of one main surface of the sheet-like member 30 across the transmission member 40 in a state where the transmission member 40 is disposed on one main surface of the sheet-like member 30 to fix the transmission member 40 to one main surface of the sheet-like member 30, for example. The transmission member 40 needs not be fixed to only one main surface of the sheet-like member 30. The transmission member 40 may include both a part fixed to one main surface of the sheet-like member 30 and a part fixed to the other main surface of the sheet-like member 30. In this case, the transmission member 40 may be provided to pass from one main surface toward the other main surface in an intermediate portion or an end edge portion of the sheet-like member 30.

For example, the transmission member 40 may be sandwiched between two sheets, thereby being fixed to the sheet-like member 30. For example, in a case where the sheet-like member 30 includes a plurality of layers, the transmission member 40 may be sandwiched between sheets constituting each layer. In this case, the two sheets sandwiching the transmission member 40 may be fixed by welding, or may also be fixed by an adhesive agent or a double-sided tape.

Herein, the transmission member 40 is mainly provided on a surface of the sheet-like member 30 on a side of the roof interior member 80.

The transmission member 40 is connected to the roof-side apparatus 50. The roof-side apparatus 50 transmits or receives an electrical signal or an optical signal via the transmission member 40. Alternatively, the roof-side apparatus 50 receives a power supply or distributes electrical power via the transmission member 40. The transmission member 40 and the roof-side apparatus 50 may be connected to each other via a connector. It is also applicable that the transmission member 40 is directly introduced in the roof-side apparatus 50 to be directly connected to an electrical element in the roof-side apparatus 50. One end portion of the transmission member 40 may be drawn from the sheet-like member 30. The end portion which has been drawn in the transmission member 40 may be drawn to a pillar, for example, to be connected to an electrical control unit or a power source on a lower side of the roof interior member 80 in the vehicle body.

The roof-side apparatus 50 is an apparatus disposed between the roof panel 13 and the roof interior member 80 to be a connection destination of the transmission member 40. Assumed as the roof-side apparatus 50 are, for example, an electrical control unit, a lamp (particularly, a map lamp and an interior lamp), a speaker, an interior camera, a monitor, a projection apparatus, an external communication antenna, and an interior-side antenna. A part of the roof-side apparatus 50 may be exposed inside or outside the vehicle.

The roof-side apparatus 50 may be held by any of the sheet-like member 30, the roof panel 13, and the roof interior member 80. Described in the present embodiment is an example of holding the roof-side apparatus 50 by the sheet-like member 30. When the roof-side apparatus 50 is provided to the roof panel 13 or the roof interior member 80, the transmission member 40 and the roof-side apparatus 50 may be connector-connected while the sheet-like member 30 is disposed between the roof panel 13 and the roof interior member 80. An arrangement position of the roof-side apparatus 50 in the sheet-like member 30, the roof panel 13, or the roof interior member 80 is optionally set. The roof-side apparatus 50 is preferably fixed to a position appropriate for a role of the roof-side apparatus 50 on the sheet-like member 30, the roof panel 13, or the roof interior member 80. For example, assuming that the roof-side apparatus 50 is a map lamp, the roof-side apparatus 50 may be fixed to a portion to be disposed in an obliquely upper front position of a front seat. When the roof-side apparatus 50 and the transmission member 40 are disposed on the surfaces of the sheet-like member 30 on sides opposite to each other, the transmission member 40 may pass through the sheet-like member be connected to the roof-side apparatus 50.

The roof-side apparatus 50 may be finally fixed to the roof panel 13 or the roof interior member 80 even when the roof-side apparatus 50 is held by the sheet-like member 30. Thus, it is sufficient that the roof-side apparatus 50 is held by the sheet-like member 30 at holding force so that the roof-side apparatus 50 is kept in a constant position in the sheet-like member 30. For example, the roof-side apparatus 50 may be fixed to the sheet-like member 30 by an adhesive agent, a gluing agent, or a double-sided tape. The roof-side apparatus 50 may be fixed to the sheet-like member 30 with a screw or a pin, for example. The roof-side apparatus 50 may be fixed to the sheet-like member 30 via the intermediate support member 60. In this case, the roof-side apparatus 50 may be fixed to the intermediate support member 60 by an adhesive agent, a gluing agent, or a double-sided tape, or may also be fixed with a screw or a pin, for example.

The intermediate support member 60 is a member disposed to the side of the vehicle interior of the roof panel 13. The intermediate support member 60 is supported by the roof panel 13, thereby being disposed in a constant position in the roof panel 13. The present intermediate support member 60 supports the roof interior member 80. Thus, the roof interior member 80 is supported by the roof panel 13 via the intermediate support member 60. The intermediate support member 60 achieves support by the roof panel 13 and support of the roof interior member 80, thus the intermediate support member 60 includes a panel-side fixing part 70 and an interior member-side fixing part 68.

In the present embodiment, the intermediate support member 60 has a role of supporting the sheet-like member 30 so that the sheet-like member 30 planarly extends.

More specifically, the intermediate support member 60 may be formed to be an elongated member having higher rigidity than the sheet-like member 30. For example, the sheet-like member 30 may be a stacked body of an aluminum foil and a non-woven cloth, and the intermediate support member 60 may be a plate-like material or a rod-like material made of solid resin with solid material (for example, polypropylene (PP) or polyamide (PA)). The intermediate support member 60 may be a member achieving weight saving while having strength such as a honey comb structure member. The intermediate support member 60 may be formed by metal such as iron or aluminum, for example.

The intermediate support member 60 is fixed to the sheet-like member 30 by an adhesive agent, a gluing agent, a double-sided tape, or welding (ultrasonic welding or thermal welding), for example. The intermediate support member 60 may be fixed to the sheet-like member 30 with a screw or a pin, for example. Herein, the intermediate support member 60 is formed into an elongated rectangular plate-like shape. A length dimension of the intermediate support member 60 is set to be the same as a width dimension of the sheet-like member 30. The length dimension of the intermediate support member 60 may be smaller than the width dimension of the sheet-like member 30 as long as an edge of the sheet-like member 30 does not hang immediately downward (for example, smaller within a range of 20 cm or less). The intermediate support member 60 is disposed on the surface of the sheet-like member 30 on the side of the roof panel 13.

In the present embodiment, the plurality of (herein, four) intermediate support members 60 are fixed to the sheet-like member 30. The length direction of each intermediate support member 60 follows the width direction of the sheet-like member 30. Thus, a part of the sheet-like member 30 provided with the intermediate support member 60 is kept in a state of hardly hanging downward in the width direction.

The plurality of intermediate support members 60 are provided at intervals in a front-back direction of the sheet-like member 30. Thus, the sheet-like member 30 may be bended between the plurality of intermediate support members 60. When the present roof module 21 is stored or transported, a space for storing or transporting the roof module 21 can be reduced by folding the sheet-like member 30 between the plurality of intermediate support members 60.

An arrangement region where the intermediate support member 60 is disposed on the sheet-like member 30 is a region where a portion where the intermediate support member 60 is attached is provided. In the present embodiment, the intermediate support member 60 is provided to a lower side of the roof reinforcement member 14.

The intermediate support member 60 includes the panel-side fixing part 70 fixed to the roof panel 13. Provided herein is the panel-side fixing part 70 protruding toward an upper side of the intermediate support member 60. The panel-side fixing part 70 is a part fixed to the roof panel 13, herein the roof reinforcement member 14. The panel-side fixing part 70 may be a clip-shaped part fixed by insertion so as not to come out from the roof reinforcement member 14, for example. For example, the panel-side fixing part 70 may have a configuration that formed in a rod-like pillar part is a pair of wing-like elastic pieces outwardly inclined from a tip end portion toward a base end portion of the pillar part. For example, the panel-side fixing part 70 may be a tree-like clip in which an umbrella-like elastic piece is formed in the rod-like pillar part. The panel-side fixing part 70 may be a screw. Also applicable is a configuration that a fixing part provided to protrude on a side of the roof panel 13 is fixed to a fixing part including a hole formed in the intermediate support member 60. That is to say, the panel-side fixing part may have a hole-like shape. The number and positions of the panel-side fixing parts 70 provided to the intermediate support member 60 are optionally set. It is preferable that three or more panel-side fixing parts 70 are provided to the intermediate support member 60. Described in the present embodiment is an example that four panel-side fixing parts 70 are provided to an inner side of four corners of the intermediate support member 60.

A part of the sheet-like member 30 where the intermediate support member 60 is provided is easily kept in a planar form. Thus, an operation of assembling the intermediate support member 60 to the roof panel 13 can be easily performed while the sheet-like member 30 and the transmission member 40 held by the sheet-like member 30 are kept in a planar form.

The intermediate support member 60 includes the interior member-side fixing part 68 to which the roof interior member 80 is fixed. Provided herein is the interior member-side fixing part 68 protruding toward a lower side of the intermediate support member 60. An opening 30h through which the interior member-side fixing part 68 can pass is formed in a position in the sheet-like member 30 corresponding to the interior member-side fixing part 68. Accordingly, the interior member-side fixing part 68 can pass through the sheet-like member 30 to protrude to a lower side. The interior member-side fixing part 68 is assumed to be a clip-shaped part fixed by insertion so as not to come out from the sheet-like member 30 or a screw, for example, in the manner similar to the panel-side fixing part 70. The fixing part protruding from a side of the roof interior member 80 toward a side of the intermediate support member 60 may have a configuration of being fixed to a hole formed in the intermediate support member 60. That is to say, the interior member-side fixing part 68 may have a shape including a hole.

The number and positions of the interior member-side fixing part 68 provided to the intermediate support member 60 are optionally set. It is preferable that three or more interior member-side fixing parts 68 are provided to the intermediate support member 60. It is preferable that the interior member-side fixing part 68 is provided in a position away from the transmission member 40 and the roof-side apparatus 50. Described in the present embodiment is an example that four interior member-side fixing parts 68 are provided to an inner side of four corners of the intermediate support member 60 (in FIG. 3, an inner side of the panel-side fixing part 70).

### <Roof Interior Member>

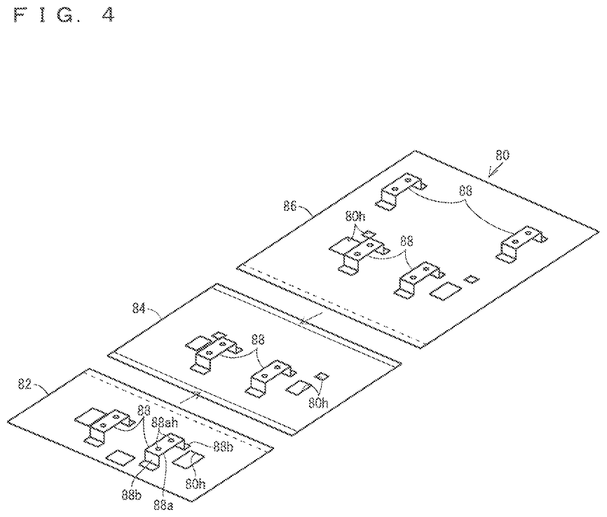

FIG. 4 is an exploded perspective view illustrating the roof interior member 80. As illustrated in FIG. 2 and FIG. 4, the roof interior member 80 is a member covering the roof panel 13 from the side of the vehicle interior. The roof interior member 80 is exposed to the side of the vehicle interior. The roof interior member 80 extends to an upper side of a front seat and a rear seat. When the vehicle 10 includes a third row of seat, the roof interior member 80 also extends to an upper side of the third row of seat. When a space on the seat and a luggage room space are continuously formed in the vehicle 10, the roof interior member 80 also extends to an upper side of a luggage room. A length of the roof interior member 80 in the front-back direction of the vehicle may be equal to or lager than 2 m, may be 2.5 m, or may also be equal to or larger than 3 m. The length of the roof interior member 80 in the front-back direction of the vehicle may be equal to or smaller than 2 m, equal to or smaller than 3 m, equal to or smaller than 4 m, or equal to or smaller than 5 m.

The roof interior member 80 includes a plurality of segmented roof interior members 82, 84, and 86. The plurality of segmented roof interior members 82, 84, and 86 form a continuous body continuously formed in a state of extending in different regions in the roof panel 13 to have a shape of covering the roof panel 13 from the side of the vehicle interior. The number of divisions of the roof interior member 80 and a divisional line thereof are optionally set. In the present embodiment, the roof interior member 80 is divided into three pieces. The roof interior member 80 is divided into plural pieces in the front-back direction of the vehicle. Thus, a boundary line between the segmented roof interior members 82, 84, and 86 follows a vehicle width direction. It is also applicable that the segmented roof interior member 82 is disposed in a region covering an upper side of a front seat, the segmented roof interior member 84 is disposed in a region covering an upper side of a second row of seat, and the segmented roof interior member 86 is disposed in a region covering a back side of the second row of seat (for example, a third row of seat or a luggage room, for example). Accordingly, maintenance of the roof-side apparatus 50 can be easily performed for each region of the front seat, the second row of seat, and the back side of the second row of seat.

The length of each of the segmented roof interior members 82, 84, and 86 in the front-back direction of the vehicle 10 may be equal to or smaller than 2 m, equal to or smaller than 1.5 m, or equal to or smaller than 1 m. The length of each of the segmented roof interior members 82, 84, and 86 in the front-back direction of the vehicle 10 may be equal to or larger than 50 cm or equal to or larger than 1 m.

An opening 80h for exposing the roof-side apparatus 50 to the inner side of the vehicle may be formed in the segmented roof interior members 82, 84, and 86. Assumed as the roof-side apparatus 50 exposed to the inner side of the vehicle are a room lamp and a camera, for example.

The segmented roof interior members 82, 84, and 86 are supported by the intermediate support member 60. Herein, the first intermediate support member 60 from the front supports the first segmented roof interior member 82 from the front in the front-back direction of the vehicle. The second previous intermediate support member 60 from the front supports the second segmented roof interior member 84 from the front in the front-back direction of the vehicle. The first and second intermediate support members 60 from the back support the first segmented roof interior member 86 from the back in the front-back direction of the vehicle.

The boundary between the plurality of segmented roof interior members 82, 84, and 86 is located between the plurality of intermediate support members 60. Herein, the boundary between the segmented roof interior members 82 and 84 is located between the first intermediate support member 60 from the front and the second intermediate support member 60 from the front. The boundary between the segmented roof interior members 84 and 86 is located between the second intermediate support member 60 from the front and the third intermediate support member 60 from the front. Thus, the intermediate support member 60 can support the segmented roof interior members 82, 84, and 86 in a position closer to an inner side in relation to an outer edge of the segmented roof interior members 82, 84, and 86.

The segmented roof interior members 82, 84, and 86 are supported by the intermediate support member 60, thus the segmented roof interior members 82, 84, and 86 are provided with a support bracket 88. The support bracket 88 is formed of metal or resin, for example. The support bracket 88 includes a support plate part 88a and a leg part 88b. The support plate part 88a is formed into a plate-like shape. A fixing hole 88ah to which the interior member-side fixing part 68 is inserted and fixed is formed in the support plate part 88a. Herein, the two fixing holes 88ah are formed in the support plate part 88a. The leg part 88b extends from the support plate part 88a toward a side of the segmented roof interior members 82, 84, and 86. A lower end portion of the leg part 88b is fixed to upward surfaces of the segmented roof interior members 82, 84, and 86. The leg part 88b can be fixed to the segmented roof interior members 82, 84, and 86 by screwing, a fitting structure, or welding, for example. Herein, the pair of the leg parts 88b are provided to both ends of one support plate part 88a, however, also applicable is a configuration that one leg part 88b is provided to one support plate part 88a.

Two support brackets 88 are fixed to the segmented roof interior member 82 at positions away from each other in the vehicle width direction. In this fixing state, two fixing holes 88ah in the support bracket 88 are arranged side by side in the front-back direction of the vehicle. Accordingly, the fixing holes 88ah to which four interior member-side fixing parts 68 on the side of the intermediate support member 60 can be inserted and fixed are formed by two support brackets 88 fixed to the segmented roof interior member 82.

In the similar manner, two support brackets 88 are fixed to the segmented roof interior member 84. In the similar manner, four support brackets 88 are fixed to the segmented roof interior member 86, and the fixing holes 88ah to which eight interior member-side fixing parts 68 in total on the side of the intermediate support member 60 can be inserted and fixed are formed therein. A space where the roof-side apparatus 50 can be disposed can be easily ensured between the intermediate support member 60 and the roof interior member 80 by the support bracket 88.

The number and positions of the support brackets 88 in the segmented roof interior members 82, 84, and 86 are appropriately set in accordance with the number and positions of the interior member-side fixing parts 68 in the intermediate support members 60.

It is not necessary to provide the fixing hole 88ah into which the interior member-side fixing part 68 is inserted by adding the support bracket 88. A fixing hole may be directly formed in the segmented roof interior member 82. As described above, there is a case where the protrusion part is formed in the segmented roof interior member 82 for fixation, and the hole is formed in the intermediate support member 60 through which the protrusion part is inserted and passes.

Edges of the segmented roof interior members 82, 84, and 86 may be pressed by an upper end of the interior member exposed to the vehicle interior while the segmented roof interior members 82, 84, and 86 are fixed to the intermediate support member 60. For example, the segmented roof interior members 82, 84, and 86 may be pressed toward the roof panel 13 by the interior member on an inner side of the pillar.

Edges of the segmented roof interior members 82, 84, and 86 in the boundary may be overlapped with each other in the thickness direction thereof while the segmented roof interior members 82, 84, and 86 are fixed to the intermediate support member 60. Described herein is an example that a front edge of the segmented roof interior member 84 in an intermediate portion of the vehicle in the front-back direction is overlapped on a back edge of the segmented roof interior member 82 on a front side, and a back edge of the segmented roof interior member 84 in the intermediate portion of the vehicle in the front-back direction is overlapped on a front edge of the segmented roof interior member 86 on a back side. A vertically structured relationship of the overlap may be reversed. It is not necessary to overlap the edges of the segmented roof interior members 82, 84, and 86.

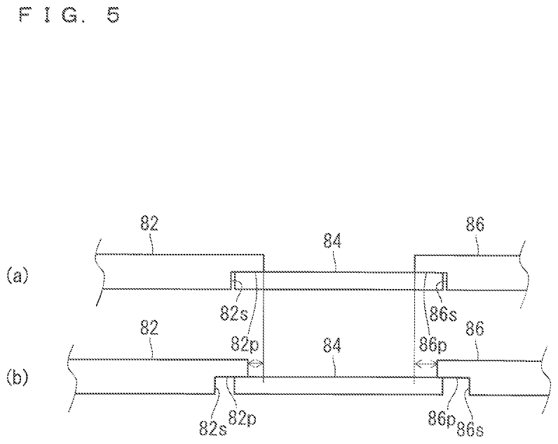

FIG. 5 schematically illustrates an example that the edges of the segmented roof interior members 82, 84, and 86 are overlapped with each other. In FIG. 5, a concave part 82p concaved via a step part 82s is formed in a downward part of a back edge of the segmented roof interior member 82. A concave part 86p concaved via a step part 86s is formed in a downward part of a front edge of the segmented roof interior member 86. A level difference between the step parts 82s and 86s is set to be the same, and the segmented roof interior member 84 is formed to have substantially the same thickness as a level difference between the step parts 82s and 86s. Accordingly, surfaces of the segmented roof interior members 82, 84, and 86 directed to a vehicle interior are disposed on the same plane as much as possible.

As illustrated in (a) of FIG. 5 when the segmented roof interior members 82, 84, and 86 have a relatively close relationship as a result of a configuration that the segmented roof interior members 82, 84, and 86 are supported by the intermediate support member 60, the front edge and the back edge of the segmented roof interior member 84 are disposed in a position close to the step parts 82s and 86s in the concave parts 82p and 86p. In contrast, as illustrated in (b) of FIG. 5, when the segmented roof interior members 82, 84, and 86 have a relatively closer relationship than the case illustrated in (a) as a result of a configuration that the segmented roof interior members 82, 84, and 86 are supported by the intermediate support member 60, the front edge and the back edge of the segmented roof interior member 84 are disposed in a position away from the step parts 82s and 86s in the concave parts 82p and 86p.

The displacement between the segmented roof interior members 82, 84, and 86 described above may occur in accordance with displacement of the intermediate support member 60 in relation to the roof panel 13 and displacement of the segmented roof interior members 82, 84, 86 in relation to the intermediate support member 60 caused by a manufacturing error and an assembly error, for example. In any case, the edges of the segmented roof interior members 82, 84, and 86 are vertically overlapped with each other, and a gap is hardly observed between the segmented roof interior members 82, 84, and 86 in a plan view.

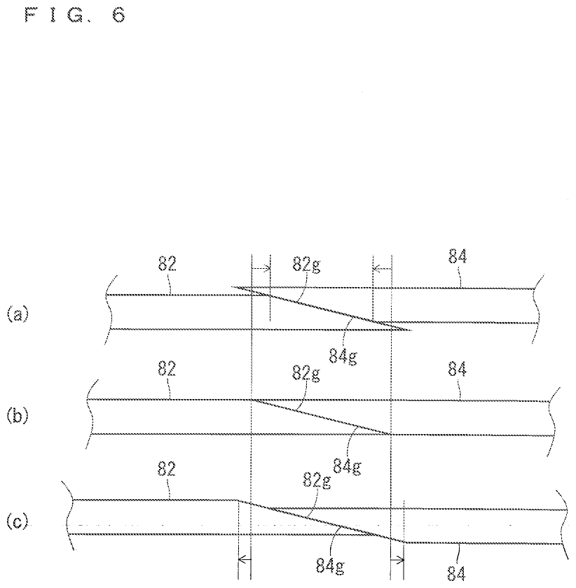

As illustrated in FIG. 6, an inclined surface may be formed in an edge of any of the segmented roof interior members 82, 84, and 86. For example, an inclined surface 82g is formed in a back edge of the segmented roof interior member 82, and an inclined surface 84g is formed in a front edge of the segmented roof interior member 84. The inclined surfaces 82g and 84g facing each other are surfaces parallel to each other.

In this case, as illustrated in (b) of FIG. 6, when the segmented roof interior members 82 and 84 are adjacent to each other in a design ideal positional relationship, the inclined surface 82g and the inclined surface 84g can wholly have contact with each other. As illustrated in (a) of FIG. 6, when the segmented roof interior members 82 and 84 are closer to each other than that in the positional relationship illustrated in (b) of FIG. 6, the inclined surface 82g and the inclined surface 84g extend over each other, and the gap is hardly observed between the segmented roof interior members 82 and 84. As illustrated in (c) of FIG. 6, even when the segmented roof interior members 82 and 84 are closer to each other that that in the positional relationship illustrated in (b) of FIG. 6, the inclined surface 82g and the inclined surface 84g may have a positional relationship of being overlapped with each other in a plan view, thus the gap is hardly observed in a plan view. In this case, when a vertical position of any of the segmented roof interior members 82 and 84 are adjusted, the inclined surface 82g and the inclined surface 84g can have contact with each other.

When the segmented roof interior members 82, 84, and 86 are overlapped with each other, any of the segmented roof interior members 82, 84, and 86 overlapped on the side of the vehicle interior can be easily detached to the side of the vehicle interior. Any of the segmented roof interior members 82, 84, and 86 overlapped on the side of the roof panel 13 can also be easily detached to the side of the vehicle interior by elastically deforming the segmented roof interior members 82, 84, and 86 or displacing them forward or backward.

### <Support Structure of Intermediate Support Member and Roof Interior Member on Roof Panel>

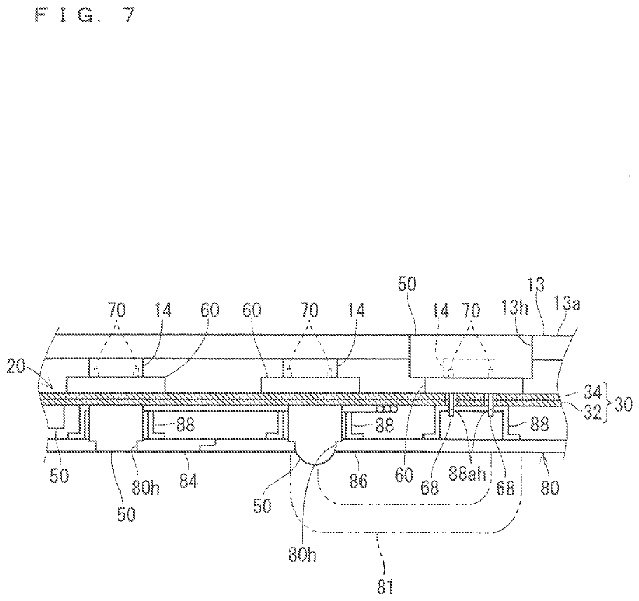

FIG. 7 is a schematic cross-sectional view illustrating a support structure of the intermediate support member 60 and the segmented roof interior member 82 on the roof panel 13. FIG. 7 illustrates parts of the segmented roof interior member 84 and 86 supported on the roof panel 13 via the intermediate support member 60. A dimension of each part may be exaggerated or shrunk for convenience of explanation. A part of the roof-side apparatus 50 is omitted.

FIG. 7 illustrates the roof reinforcement member 14 reinforcing the panel body 13a of the roof panel 13. As illustrated in FIG. 7, the intermediate support member 60 is fixed to the roof reinforcement member 14 via the panel-side fixing part 70. The sheet-like member 30 is located on the side of the roof interior member 80 of the intermediate support member 60. When the opening 13h is formed in the panel body 13a, the roof reinforcement member 14 may be formed in an intermediate portion to the opening 13h, or may also be bended halfway through to pass around the opening 13h.

The roof-side apparatus 50, for example, is held on the surface of the sheet-like member 30 on the side of the roof interior member 80. A part of the roof-side apparatus 50 is disposed between the lower surface of the sheet-like member 30 and the roof interior member 80. The other part of the roof-side apparatus 50 is fitted into the opening 80h formed in the roof interior member 80 to be exposed to the inner side of the vehicle. The other roof-side apparatus 50 (external communication antenna unit, for example) is provided on the surface of the sheet-like member 30 on the side of the roof panel 13. It is sufficient that the intermediate support member 60 located between the roof-side apparatus 50 and the sheet-like member 30 is fixed to the roof reinforcement member 14 on an outer side of the roof-side apparatus 50 via the panel-side fixing part 70. The roof-side apparatus 50 on an upper side of the sheet-like member 30 is exposed to an outer side via the opening 13h formed in the roof panel 13.

The sheet-like member 30 is disposed between the roof interior member 80 and the roof panel 13. As described above, the sheet-like member 30 includes a layer having at least one of a heat insulation function, an acoustic insulation function, and/or a radio wave shielding function. In FIG. 7, the sheet-like member 30 includes a non-woven layer 32 and a radio wave shielding layer 34. Herein, the sheet-like member 30 has a multilayer structure in which the non-woven layer 32 and the radio wave shielding layer 34 are overlapped with each other from a lower side to an upper side.

The segmented roof interior members 82, 84, and 86 are supported on the roof panel 13 via the intermediate support member 60. For example, as described above, the support bracket 88 is fixed to the segmented roof interior members 82, 84, and 86. The interior member-side fixing part 68 of the intermediate support member 60 is inserted and fixed to the fixing hole 88ah formed in the support bracket 88 while the support bracket 88 is disposed on the lower side of the intermediate support member 60. Accordingly, the segmented roof interior members 82, 84, and 86 are fixed to the intermediate support member 60.

A handle 81 may be formed on the surface of the segmented roof interior members 82, 84, and 86 on the side of the vehicle interior. The handle 81 is formed into a shape so as to be easily gripped by a hand of a person such as a flat U-like shape, an annular shape, or an L-like shape, for example. An operator grips this handle 81 and pulls the handle 81 to the side of the vehicle interior, thus the interior member-side fixing part 68 can be easily pulled from the fixing hole 88ah. Accordingly, an operation of detaching the segmented roof interior members 82, 84, and 86 can be easily performed.

All of the segmented roof interior members 82, 84, and 86 need not be supported on the roof panel 13 via the intermediate support member 60.

### <Effect Etc.>

According to the present embodiment, the plurality of segmented roof interior members 82, 84, and 86 form a continuous body continuously formed in a state of extending in different regions in the roof panel 13 to be able to cover the roof panel 13 from the side of the vehicle interior. Thus, a part of the plurality of segmented roof interior members 82, 84, and 86 can be detached to perform maintenance of the transmission member 40 and the roof-side apparatus 50 disposed between the roof panel 13 and the roof interior member 80. Assumed as the maintenance are replacement and repair of the transmission member 40 and the roof-side apparatus 50 having a defect. Thus, maintenance properties of the transmission member 40 and the roof-side apparatus 50 disposed between the roof panel 13 and the roof interior member 80 can be improved. The transmission member 40 and the roof-side apparatus 50 can also be easily added between the roof panel 13 and the roof interior member 80.

The edges in the boundary between the segmented roof interior members 82, 84, and 86 are overlapped with each other. Thus, the gap hardly occurs at the boundary between the segmented roof interior members 82, 84, and 86 even in a case where an error occurs in an assembly position of the segmented roof interior members 82, 84, and 86.

In the interior member-equipped roof module 20 including the roof interior member 80 including the plurality of segmented roof interior members 82, 84, and 86 and the intermediate support member 60 which can be attached to the roof panel 13, at least one of the plurality of segmented roof interior members 82, 84, and/or 86 is supported on the roof panel 13 via the intermediate support member 60. Thus, at least one of the segmented roof interior members 82, 84, and/or 86 is easily and firmly supported on the roof panel 13 via the intermediate support member 60.

At least one of the roof-side apparatus 50 and/or the transmission member 40 is supported by the intermediate support member 60. Thus, the intermediate support member 60 supports the segmented roof interior members 82, 84, and 64 and at least one of the roof-side apparatus 50 and/or the transmission member 40, and the configuration can be simplified. When focusing on the configuration simplified by the intermediate support member 60 having both the function of supporting the roof interior member 80 and the function of supporting at least one of the roof-side apparatus 50 and/or the transmission member 40, it is not necessary to divide the roof interior member 80 into the plurality of divided roof interior members 82, 84, and 86.

The intermediate support member 60 supports the sheet-like member 30 in a planarly extending form, thus the sheet-like member 30 is easily incorporated into the side of the vehicle interior of the roof panel 13.

The boundary between the plurality of segmented roof interior members 82, 84, and 86 is located between the plurality of intermediate support members 60. Thus, the intermediate portion on a side closer to the inner side in relation to the outer edges of the segmented roof interior members 82, 84, and 86 can be firmly supported by the intermediate support member 60.

### <Modification Example Etc.>

Various modification examples are described based on a premise of the embodiment 1.

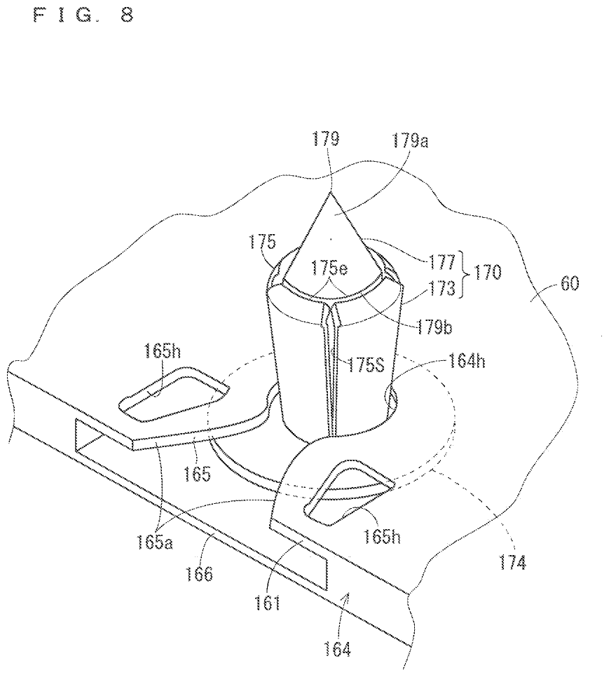

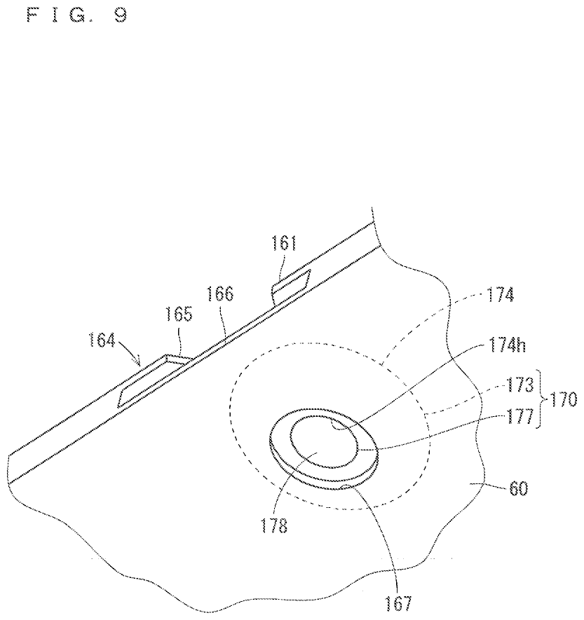

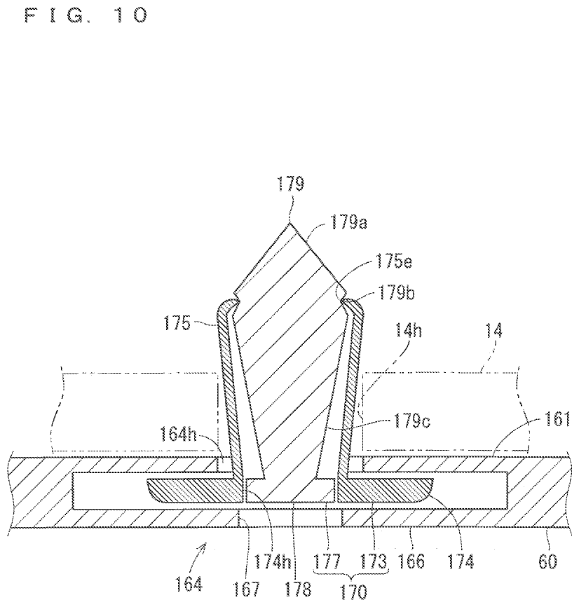

FIG. 8 and FIG. 9 are drawings each illustrating a modification example of position-adjustably supporting a fixing part 170 by a movable support part 164 provided to the intermediate support member 60. FIG. 10 is a cross-sectional view illustrating the fixing part 170.

The fixing part 170 may be a panel-side fixing part or a roof-side fixing part. When the fixing part 170 is directed upward in relation to the intermediate support member 60, the fixing part 170 can be used as the panel-side fixing part. When the fixing part 170 is directed downward, the fixing part 170 can be used as the roof-side fixing part.

In the present modification example, the intermediate support member 60 includes the movable support part 164 position-adjustably supporting the fixing part 170 in a direction in which the roof panel 13 or the roof interior member 80 extends. Thus, the fixing part 170 is position-adjustably supported by the intermediate support member 60 in the direction in which the roof panel 13 or the roof interior member 80 extends.

More specifically, the movable support part 164 formed in the intermediate support member 60 includes a holding hole 164h. The holding hole 164h is formed in a plate-like part 161 of the intermediate support member 60. That is to say, the plate-like part 161 extending along a direction of a main surface of the intermediate support member 60 is provided. The plate-like part 161 may be a part integrally formed with a body part of the intermediate support member 60 holding the sheet-like member 30, or may also be a part attached to the body part separately by welding, bonding, screwing, or a fitting structure, for example.

The holding hole 164h is formed in a position directed from an edge of the plate-like part 161 toward an inner side thereof. The holding hole 164h is formed into a circular hole-like shape. An introduction part 165 having a slit-like shape is formed to be directed from the holding hole 164h toward the edge of the plate-like part 161. The introduction part 165 includes a pair of guide edges 165a gradually narrowing from the edge of the plate-like part 161 toward the holding hole 164h. A relief opening 165h is formed in a portion away from the pair of guide edges 165a. Thus, the pair of guide edges 165a can be elastically deformed to narrow the relief opening 165h and widening a portion between the pair of guide edges 165a.

An auxiliary plate-like part 166 is formed away from the plate-like part 161. A hole 167 is formed in a part of the auxiliary plate-like part 166 facing the holding hole 164h. A space where a head part 174 described hereinafter can be disposed is provided to a surrounding part of the holding hole 164h described above between the plate-like part 161 and the auxiliary plate-like part 166. The auxiliary plate-like part 166 may be omitted. The fixing part 170 includes a fitting body part 173 and a fitting state holding pin 177.

The fitting body part 173 is a member formed of resin, for example, and includes the head part 174 and an insertion part 175. The head part 174 is formed into a circular plate-like shape. The insertion part 175 is formed into a shape protruding from one main surface of the head part 174. More specifically, the insertion part 175 is formed into a cylindrical shape. A plurality of slits 175S are formed in the insertion part 175 along an axis direction of the insertion part 175. A tip end portion 175e of the insertion part 175 is formed into a shape directed inward. The insertion part 175 can be deformed to widen a tip end side thereof.

An opening 174h is formed in the head part 174 described above. The fitting state holding pin 177 is fitted in the insertion part 175 from the opening 174h. The fitting state holding pin 177 includes a pin head part 178 and a columnar part 179. The pin head part 178 is formed into a circular plate-like shape so that it can be disposed in the opening 174h. The columnar part 179 is formed into an elongated shape protruding from the pin head part 178. The tip end portion of the pin head part 178 is formed in a first guide surface 179a gradually thickened from a tip end side toward a base end side. An intermediate portion of the pin head part 178 in a longitudinal direction is formed in a groove part 179b concaved inward along a circumferential direction thereof. The tip end portion 175e of the insertion part 175 described above is fitted in this groove part 179b. The base end portion of the pin head part 178 is formed in a second guide surface 179c gradually thinned from the tip end side toward the base end side.

The hole 167 in the auxiliary plate-like part 166 described above is formed to have a larger outer diameter than an outer diameter of the pin head part 178.

In an initial state, the pin head part 178 of the fitting state holding pin 177 protrudes to an outer side of the head part 174 of the fitting body part 173. A base end portion of the insertion part 175 in the fixing part 170 is held in the holding hole 164h described above, and the head part 174 is disposed between the plate-like part 161 and the auxiliary plate-like part 166, thus the fixing part 170 is supported on the intermediate support member 60. In this state, the insertion part 175 is held by a narrowed portion between the holding hole 164h and the introduction part 165 so that it does not come out of the holding hole 164h. In this state, the fixing part 170 is position-adjustable in the direction in which the roof panel 13 and the roof interior member 80 extend within a range in which the fixing part 170 is movable in the holding hole 164h.

Assuming that the fixing part 170 is the panel-side fixing part, when the intermediate support member 60 is fixed to the roof reinforcement member 14, the insertion part 175 is fitted in a fixing hole 14h formed in the roof reinforcement member 14. Subsequently, the fitting state holding pin 177 is pressed toward the fitting body part 173. Then, the tip end portion 175e of the insertion part 175 is pressed outward by the first guide surface 179a of the pin head part 178. Accordingly, an outward part of the tip end portion of the insertion part 175 is locked to or has contact with the fixing hole 14h formed in the roof reinforcement member 14 so as not to come out of the fixing hole 14h. The fitting state holding pin 177 is further pressed into the fixing hole 14h, and the tip end portion 175e of the insertion part 175 is fitted in the groove part 179b of the pin head part 178, thus the fixing part 170 is kept in a state of being fitted in the fixing hole 14h formed in the roof reinforcement member 14. In this state, an outward surface of the pin head part 178 may be located on an extension line of an outward surface of the head part 174. Accordingly, the pin head part 178 is hardly pressed therein unnecessarily.

When the pin head part 178 is further pressed from the state described above, the fitting state where the tip end portion 175e of the insertion part 175 is fitted in the groove part 179b of the pin head part 178 is released, and the tip end portion 175e of the insertion part 175 can retract inward in relation to the second guide surface 179c of the pin head part 178. Accordingly, a locking state or a contact state between the outward portion of the tip end portion of the insertion part 175 and the fixing hole 14h is released, and the fixing part 17 can be detached from the fixing hole 14h. According to such a configuration, the intermediate support member 60 can be easily attached to and detached from the reinforcement member. It is preferable to form a hole in the sheet-like member 30 and press the pin head part 178.

Even when the fixing part 170 is the interior member-side fixing part 68, the fixing part 170 can be inserted and fixed to the fixing hole 88ah formed in the support bracket 88 on the side of the segmented roof interior members 82, 84, and 86 in the manner similar to the above description.

Also as described in the embodiment 1, in the relationship between the roof reinforcement member 14 and the intermediate support member 60, optionally set are the member 14 or 60 to which the protruding fixing part is provided and the member 14 or 60 to which the fixing part including the hole to which the protruding fixing part is fitted and fixed is provided. Also in the relationship between the intermediate support member 60 and the segmented roof interior members 82, 84, and 86, optionally set are the member 60 or any of the members 82, 84, and 86 to which the protruding fixing part is provided and the member 60 or any of the members 82, 84, and 86 to which the fixing part including the hole to which the protruding fixing part is fitted and fixed is provided.

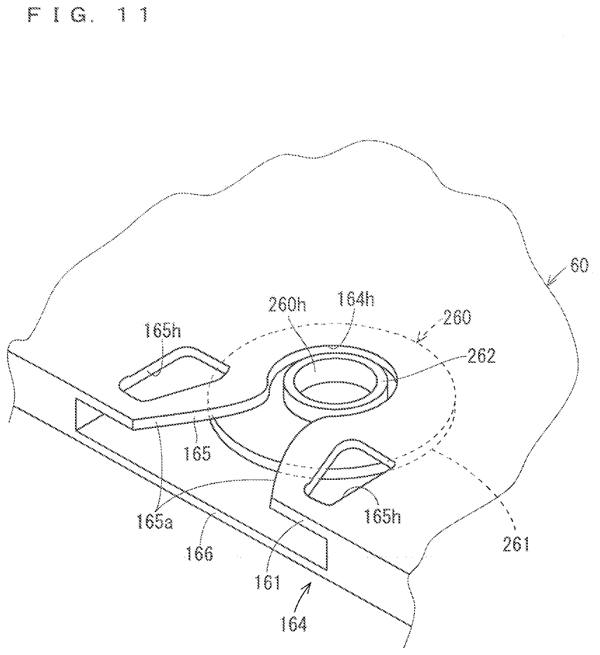

When the panel-side fixing part or the interior member-side fixing part is a fixing part including the hole, a fixing part 260 as a hole may be position-adjustably supported by the movable support part 164 as illustrated in FIG. 11.

In the example illustrated in FIG. 11, the fixing part 260 includes a head part 261 and a cylindrical part 262. A hole as a fixing hole 260h passing from the cylindrical part 262 to the head part 261 is formed in the fixing part 260. The head part 261 protrudes from one end portion of the cylindrical part 262 to an outer periphery side. The cylindrical part 262 is held in the holding hole 164h in the movable support part 164, and the head part 261 is disposed between the plate-like part 161 and the auxiliary plate-like part 166. Accordingly, the fixing part 260 having the fixing hole 260h is position-adjustably supported within a range in which the cylindrical part 262 is movable in the holding hole 164h.

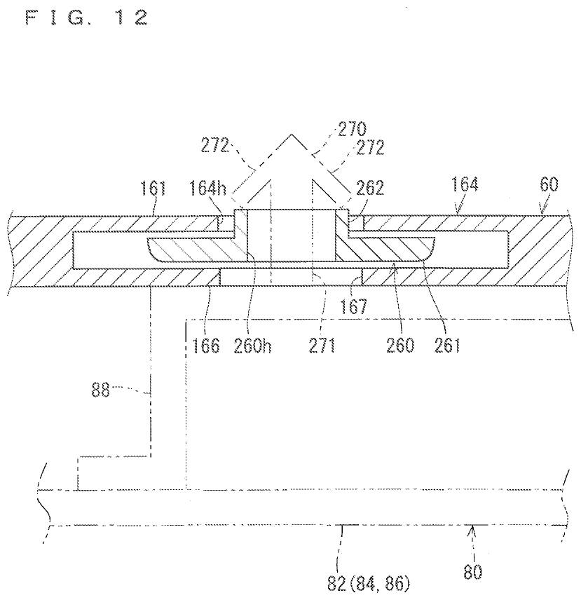

When the fixing part 260 illustrated in FIG. 11 is provided to the intermediate support member 60, a fixing part 270 protruding upward may be provided to the support bracket 88 of the segmented roof interior members 82, 84, and 86 as illustrated in FIG. 12. The fixing part 270 may have a configuration that an elastically deformable elastic piece 272 is provided to a pillar part 271, for example. The elastic piece 272 is an elastically deformable part extending in a direction from a tip end side to a base end part with decreasing distance to an outer side of the pillar part 271. When the fixing part 270 is inserted into the fixing hole 260h, the elastic piece 272 can be elastically deformed to a side of the pillar part 271. When the elastic piece 272 passes through the fixing hole 260h, the elastic piece 272 is elastically restored to have an original shape, and can be locked to the fixing bole 260h so as not to come out of the fixing hole 260h. In the present example, the fixing part 270 can get out of the fixing hole 260h by applying large force to the segmented roof interior members 82, 84, and 86 in a direction in which the fixing part 270 gets out thereof.

It is also applicable that the movable support part 164 described above is provided to the segmented roof interior members 82, 84, and 86, and the protruding fixing part or the fixing part including the hole is position-adjustably supported in the segmented roof interior members 82, 84, and 86.

In this manner, when at least one of the intermediate support member 60 and/or the segmented roof interior members 82, 84, and 86 position-adjustably supports the fixing parts 170 and 260, the protruding fixing part can be easily inserted and fixed to the fixing hole even when a manufacturing error occurs in a relative positional relationship with the protruding fixing part or the fixing part having the fixing bole to which the fixing part is locked so as not to come out thereof. Accordingly, the segmented roof interior members 82, 84, and 86 are easily fixed to the intermediate support member 60.

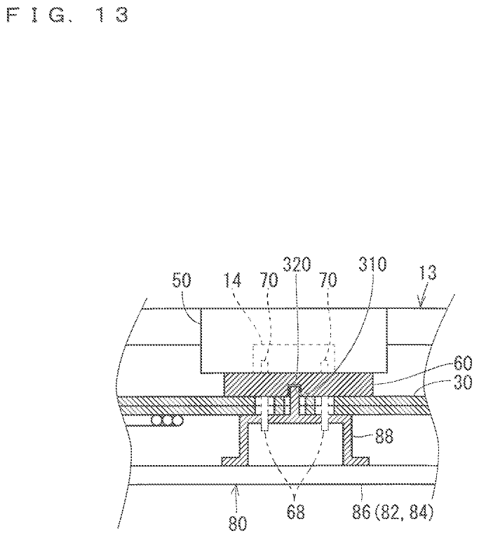

As with the modification example illustrated in FIG. 13, it is applicable that a positioning concave part 310 is formed in one of the intermediate support member 60 and the segmented roof interior members 82, 84, and 86 and a positioning convex part 320 is formed in the other one thereof. The positioning concave part 310 may include a pair of inner side surfaces facing each other in front and back of the vehicle, a pair of inner side surfaces facing each other in the vehicle width direction, or surfaces surrounding the whole vehicle in the front-back direction. The positioning convex part 320 has contact with the inner surface of the positioning concave part 310, thereby positioning the segmented roof interior members 82, 84, and 86 in relation to the intermediate support member 60 in at least a direction in which the roof interior member 80 extends.

The positioning concave part 310 is formed in the intermediate support member 60 in FIG. 13. The positioning concave part 310 is formed into a rectangular hole-like shape, for example. The positioning convex part 320 is formed in the segmented roof interior member 86 as an example. In the present example, the positioning convex part 320 is provided to protrude on the support bracket 88. The positioning convex part 320 is formed into a rectangular columnar shape so as to be able to be fitted in the positioning concave part 310. A hole is formed in a part of the sheet-like member 30 where the positioning concave part 310 is formed.

The positioning convex part 320 is fitted in the positioning concave part 310, thus the segmented roof interior member 86 is positioned in relation to the intermediate support member 60 in the direction in which the roof interior member 80 extends. Accordingly, the position of the segmented roof interior member 82, 84, and 86 in relation to the intermediate support member 60 is corrected, and the segmented roof interior members 82, 84, and 86 are easily supported in a design scheduled position. Plural combinations of the positioning convex part 320 and the positioning concave part 310 may be provided.

There is also a case where the relationship between the concave part and the convex part described above is reversed, that is to say, the positioning convex part is formed in the intermediate support member 60 and the positioning concave part is formed in the segmented roof interior members 82, 84, and 86.

### Embodiment 2

A roof interior member, an interior member-equipped roof module, and a roof module according to an embodiment 2 are described hereinafter. In the following description of the present embodiment 1, the same reference numerals are assigned to the similar constituent elements described in the embodiment 2, and the description thereof will be omitted.

### <Whole Configuration>

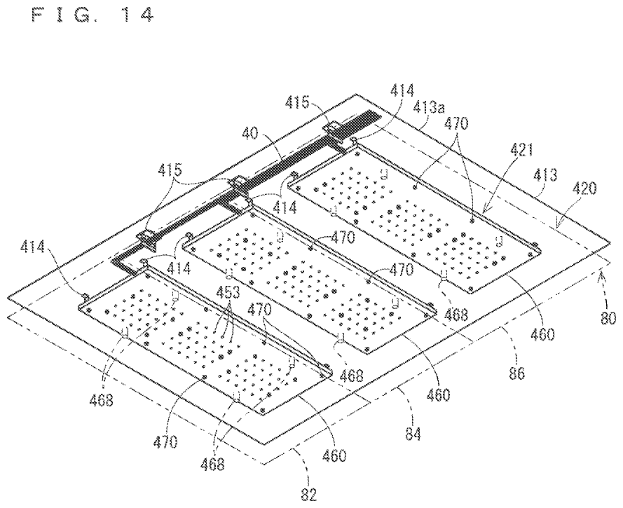

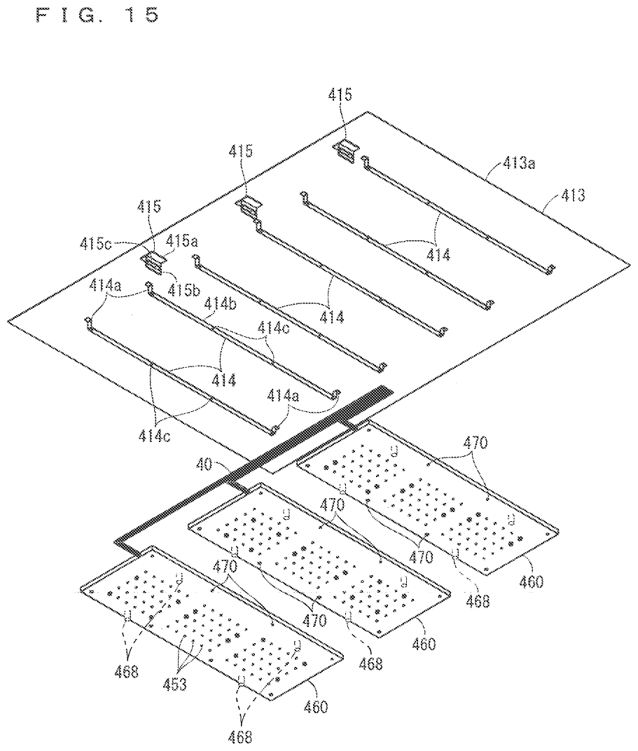

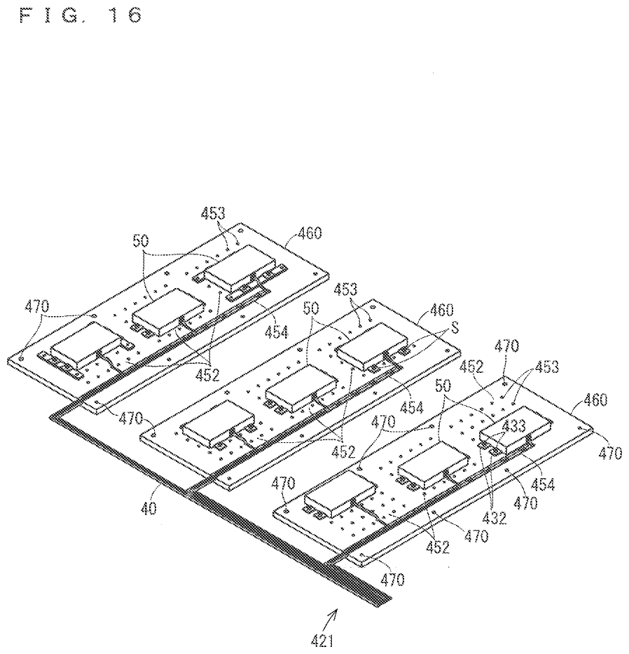

FIG. 14 is a perspective view illustrating an interior member-equipped roof module 420. FIG. 14 illustrates a roof panel 413 corresponding to the roof panel 13. The roof interior member 80 is illustrated by a chain double-dashed line. FIG. 15 is a perspective view illustrating a roof module 421 before being attached to the roof panel 413. FIG. 14 and FIG. 15 are drawings of the roof panel 413 seen from obliquely below. FIG. 16 is a perspective view illustrating the roof module 421. FIG. 16 is a drawing of the roof module 421 seen from obliquely above.

A receiving part 414 and a panel-side wiring holding part 415 are provided to a downward surface of the roof panel 413. The receiving part 414 is a member for fixing an intermediate support member 460. The panel-side wiring holding part 415 is a member for holding a part of the transmission member 40 extending to an outer side of the intermediate support member 460. When a panel body part 413a of the roof panel 413 is made of metal, the receiving part 414 and the panel-side wiring holding part 415 formed of metal may be welded to the downward surface of the panel body part 413a. The receiving part 414 and the panel-side wiring holding part 415 may be provided to a reinforcement material (also referred to as a roof reinforcement or a roof stay, for example) provided to extend across the roof in the vehicle.

In the present embodiment, the receiving part 414 is an elongated member extending along the width direction of the roof panel 413. The receiving part 414 may be a bracket provided separately from a reinforcement material referred to as a roof reinforcement or a roof stay, for example. Both end portions 414a of the receiving part 414 along an extension direction are fixed to an inner surface of the roof panel 413 by welding, for example. An intermediate portion 414b of the receiving part 414 along the extension direction is located on a lower side of both end portions 414a to be away from the roof panel 413. The receiving part 414 is formed by performing bending processing on an elongated plate-like material. The intermediate support member 460 is fixed to the intermediate portion 414b. For example, a through hole 414c is formed in the intermediate portion 414b. A panel-side fixing part 470 is inserted into the through hole 414c to fix the intermediate support member 460 to the receiving part 414. The intermediate support member 460 is hanged and supported on the roof panel 413 via the receiving part 414. Herein, one intermediate support member 460 is supported by the pair of receiving parts 414 away from each other in the front-back direction of the roof panel 413. One receiving part 414 may support one intermediate support member 460. The plurality of through holes 414c are provided at intervals in the extension direction of the receiving part 414.

The panel-side wiring holding part 415 is provided on a route of the transmission member 40. A part of the transmission member 40 extending from the intermediate support member 460 passes an edge of an outer side of the intermediate support member 460 along the width direction of the vehicle, and extends toward a front side of the vehicle along the front-back direction of the vehicle, for example. The panel-side wiring holding part 415 is provided in a position close to an edge on an outer side of the receiving part 414 along the width direction of the vehicle. The panel-side wiring holding part 415 is provided in a position corresponding to the intermediate support member 460 on the route of the transmission member 40, for example. The panel-side wiring holding part 415 is provided in the same position as the intermediate support member 460 or slightly in front of the intermediate support member 460 in the front-back direction of the roof panel 413. Accordingly, the panel-side wiring holding part 415 can hold a part of the transmission member 40, which extends from the intermediate support member 460, close to the intermediate support member 460. Particularly, the panel-side wiring holding part 415 can hold a part of the transmission member 40 close to a bending part in the front-back direction after extending to a lateral side from the intermediate support member 460.

The panel-side wiring holding part 415 includes a fixing part 415a fixed to the roof panel 413 and a holding part 415b holding the transmission member 40. In the present embodiment, the fixing part 415a is formed into a plate-like shape extending along the roof panel 413. The holding part 415b is formed into a plate-like shape extending to a lower side from the fixing part 415a. A concave part 415c housing the transmission member 40 is formed in the holding part 415b. The concave part 415c is opened to a lateral side. The transmission member 40 is housed in the concave part 415c from the opening part (refer to FIG. 14). The transmission member 40 is supported on a bottom wall of the concave part 415c, thereby being held by the holding part 415b. A part of the transmission member 40 extending to the outer side of the intermediate support member 460 is hanged and supported on the roof panel 413 via the panel-side wiring holding part 415. The opening part is smaller than the concave part 415c along a height direction of the concave part 415c. The opening part is provided to an upper side of the concave part 415e along the height direction. A sidewall of the concave part 415c is provided to a lower side of the opening part. Accordingly, suppressed is the transmission member 40 coming out of the concave part 415c through the opening part. A dimension in a width direction is larger than that in a height direction in the concave part 415c. Accordingly, the panel-side wiring holding part 415 can hold the plurality of transmission members 40 in a flat form.

In the present embodiment, the plural groups (in the present embodiment, three groups) of roof modules 421 made up of the combination of the intermediate support member 460, the receiving part 414, and the panel-side wiring holding part 415 are provided to the roof panel 413. Three pairs of receiving parts 414 are provided to be able to support three intermediate support members 460. Three intermediate support members 460 are disposed separately in the front-back direction of the vehicle. Three pairs of receiving parts 414 are disposed separately in the front-back direction of the vehicle. The plurality of (herein, three) panel-side wiring holding parts 415 are provided at intervals in the front-back direction of the roof panel 413. The transmission members 40 coming from three intermediate support members 460 are collectively fixed to at least one (herein, the panel-side wiring holding part 415 on a front side of the vehicle) of three panel-side wiring holding parts 415.

The roof interior member 80 may be the same as that described in the embodiment 1.

### <Roof Module Including Intermediate Support Member>

The roof module 421 including the intermediate support member is described more specifically. As illustrated in FIG. 14 to FIG. 16, the roof module 421 includes the roof-side apparatus 50, the transmission member 40, and the intermediate support member 460. The transmission member 40 extends from each roof-side apparatus 50. The roof-side apparatus 50 and the transmission member 40 are fixed to the intermediate support member 460. The intermediate support member 460 is fixed to the roof panel 413. The roof-side apparatus 50 and the transmission member 40 are fixed to the roof panel 413 via the intermediate support member 460. It is sufficient that the intermediate support member 460 has rigidity large enough to be able to maintain a predetermined shape in a state of being fixed to the roof panel 413 while supporting the roof-side apparatus 50 and the transmission member 40. The roof interior member 80 is fixed to the intermediate support member 460 in the manner similar to the embodiment 1 described above.

The intermediate support member 460 can flexibly correspond to a design change of a specification, a type, and the number of the roof-side apparatuses 50, for example. At least one roof-side apparatus 50 is assumed to be provided to one intermediate support member 460. Herein, the plurality of (herein, three) roof-side apparatuses 50 are provided to one intermediate support member 460. An arrangement position of the roof-side apparatus 50 in the intermediate support member 460 is optionally set. An arrangement position of the roof-side apparatus 50 in the roof panel 413 is optionally set in a state where the roof module 421 is assembled to the roof panel 413.

One end portion of the transmission member 40 is connected to the roof-side apparatus 50. The other end portion of the transmission member 40 extends toward the other apparatus (for example, the other roof-side apparatus 50, electric control unit, or power source) different from the roof-side apparatus 50 on one end portion. A part of the transmission member 40 extending from the roof-side apparatus 50 is held by the intermediate support member 460. A part of the transmission member 40 extending from the intermediate support member 460 is held by the roof panel 413. It is also applicable that a part of the transmission member 40 closer to the other end portion in relation to the part thereof held by the roof panel 413 is led out to a pillar, for example, and connected to an apparatus on a lower side of the roof interior member 80 in the vehicle.

The intermediate support member 460 includes a plurality of apparatus fixing parts 452, the panel-side fixing part 470, and an interior member-side fixing part 468. Each roof-side apparatus 50 is fixed to any apparatus fixing part 452 selected from the plurality of apparatus fixing parts 452. The roof-side apparatus 50 is fixed to the roof panel 413 by the intermediate support member 460 and the panel-side fixing part 470. Herein, the intermediate support member 460 further includes a wiring holding part 454. A part of the transmission member 40 extending from each roof-side apparatus 50 is held by the wiring holding part 454. Herein, the intermediate support member 460 is formed into an elongated rectangular plate-like shape. The intermediate support member 460 is disposed in the vehicle so that a longitudinal direction of the intermediate support member 460 follows the width direction of the vehicle. The intermediate support member 460 may be disposed in the vehicle so that a longitudinal direction of the intermediate support member 460 follows the front-back direction of the vehicle.

A plurality of fixing holes 453 are formed in a surface of the intermediate support member 460 as the plurality of apparatus fixing parts 452. Each roof-side apparatus 50 is fixed using a group of any fixing holes 453 selected from the plurality of fixing holes 453. The fixing hole 453 which is not used for fixing the roof-side apparatus 50 (fixing hole 453 which has not been selected in fixing the roof-side apparatus 50) is located in a state where the roof-side apparatus 50 is fixed to the intermediate support member 460. Herein, the roof-side apparatus 50 and the intermediate support member 460 are screwed using the fixing hole 453. The roof-side apparatus 50 and the intermediate support member 460 may be fixed by inserting a clip into the fixing hole 453, for example.

Provided are three regions in which the plurality of fixing holes 453 are regularly formed. In each region, the plurality of fixing holes 453 are arranged in a first direction and a second direction intersecting with the first direction. The first direction and the second direction are optionally set. Herein, the first direction is the longitudinal direction of the intermediate support member 460, and the second direction is a direction perpendicular to the first direction. An interval between the fixing holes 453 in the first direction and an interval between the fixing holes 453 in the second direction are optionally set. Herein, the interval between the fixing holes 453 in the first direction is an equal interval. The interval between the fixing holes 453 in the second direction is an equal interval. The interval between the fixing holes 453 in the first direction and the interval between the fixing holes 453 in the second direction are equal to each other. Three regions are arranged along the first direction. The interval between the regions in the first direction is larger than the interval between the fixing holes 453 in the first direction.

The roof-side apparatus 50 is fixed to each of three regions described above. Three roof-side apparatuses 50 are separately disposed to one intermediate support member 460 along the longitudinal direction of the intermediate support member 460. There may be an apparatus disposed over the plurality of regions. The fixing holes 453 in the plurality of regions may be used for fixing one apparatus. When the intermediate support member 460 is disposed in the vehicle so that the longitudinal direction of the intermediate support member 460 follows the width direction of the vehicle, the plurality of roof-side apparatuses 50 provided to one intermediate support member 460 are separately disposed in the width direction of the vehicle.

FIG. 16 illustrates an example that the roof-side apparatus 50 is fixed to the apparatus fixing part 452 using a screw S and a nut. A fixing piece 432 is provided to a housing of the roof-side apparatus 50. A through hole is formed in the fixing piece 432. The nut is fastened to a tip end portion of the screw S passing through the fixing hole, thus the roof-side apparatus 50 and the apparatus fixing part 452 are fixed to each other. When a female screw is formed in any of the fixing hole, the nut may be omitted. A fixing state of fixing the roof-side apparatus 50 and the apparatus fixing part 452 may be a fixing state other than fastening of screw by the screw S and the nut. For example, also applicable is a configuration that a clip is provided to protrude downward on the fixing piece 432 and the clip is locked to the fixing hole 453 formed in the apparatus fixing part 452 so as not to come out of the fixing hole 453. For example, a convex part provided to the apparatus fixing part 452 may be locked to the fixing hole 433 formed in the fixing piece 432. Moreover, the roof-side apparatus 50 may be fixed to the apparatus fixing part 452 by a rivet, for example.

As described above, the plurality of fixing holes 453 are formed side by side in the first direction and the second direction in the region where the roof-side apparatus 50 is fixed, thus the roof-side apparatus 50 can be fixed using the fixing hole in accordance with a size of the roof-side apparatus 50 to be fixed. Accordingly, various sizes of roof-side apparatus 50 can be fixed to the intermediate support member 460.

A through hole passing through the intermediate support member 460 in a thickness direction is formed as the panel-side fixing part 470. The through hole is formed in a position corresponding to the through hole 414c of the receiving part 414. Then, the nut is fastened to the tip end portion of the screw S while the screw S passes through the through hole 414c and the panel-side fixing part 470, thus the receiving part 414 and the panel-side fixing part 470 are fixed to each other. Herein, the panel-side fixing part 470 is provided in a position closer to a side edge portion of the intermediate support member 460 in relation to the apparatus fixing part 452. The plurality of (herein, four) panel-side fixing parts 470 are arranged along the longitudinal direction of the intermediate support member 460 in both side edge portions of the intermediate support member 460. Two of four panel-side fixing parts 470 are provided between three regions. The remaining two of four panel-side fixing parts 470 are provided on an outer side of three regions.

Herein, the wiring holding part 454 is a groove formed in the surface of the intermediate support member 460. The transmission member 40 is housed in the wiring holding part 454. It is also applicable that a protrusion is formed in the groove opening of the wiring holding part 454 to suppress the transmission member 40 coming out of the opening in an upper part of the wiring holding part 454.

Herein, all of the plurality of roof-side apparatuses 50 are disposed on an upper surface of the intermediate support member 460. Some or all of the plurality of roof-side apparatuses 50 may be disposed on a lower surface of the intermediate support member 460.

The transmission members 40 of the plurality of roof-side apparatuses 50 collectively extend from the intermediate support member 460 through the wiring holding part 454. Accordingly, the transmission members 40 of the plurality of roof-side apparatuses 50 can be treated as one wiring group regardless of the number of the roof-side apparatuses 50.

The intermediate support member 460 may be a member having high rigidity in the manner similar to the intermediate support member 60 described above.

The intermediate support member 460 includes the interior member-side fixing part 468 in the manner similar to the interior member-side fixing part 68. The interior member-side fixing part 468 is formed in a position corresponding to a fixing part (refer to the fixing hole 88ah) in the segmented roof interior members 82, 84, and 86. In FIG. 14 and FIG. 15, four interior member-side fixing parts 468 are provided to inner sides of four corners of the lower surface of the intermediate support member 460. Then, in the manner similar to the embodiment 2 described above, each interior member-side fixing part 468 is inserted and fixed to the fixing hole 88ah on the side of the segmented roof interior members 82, 84, and 86, thus the segmented roof interior members 82, 84, and 86 are supported by the intermediate support member 460.

### <Effect Etc.>

According to the present embodiment 2, the intermediate support member 460 directly holds at least one of the roof-side apparatus 50 and/or the transmission member 40. The intermediate support member 460 includes the panel-side fixing part 470 and the interior member-side fixing part 468. Thus, the segmented roof interior members 82, 84, and 86 are easily supported on the roof panel 413 via the intermediate support member 460. Moreover, a function effect similar to that in the embodiment 1 described above can be obtained except for the function effect by the sheet-like member 30.

Each roof-side apparatus 50 is fixed to any apparatus fixing part 452 selected from the plurality of apparatus fixing parts 452, thus such a configuration can easily deal with a change of a position of attaching the roof-side apparatus 50, a change of a specification of the roof-side apparatus 50, or installment of an additional roof-side apparatus 50, for example.

For example, the intermediate support member 460 can hold different types of roof-side apparatus 50. Thus, the following method can be adopted in manufacturing the roof module 421 assembled to the vehicle.

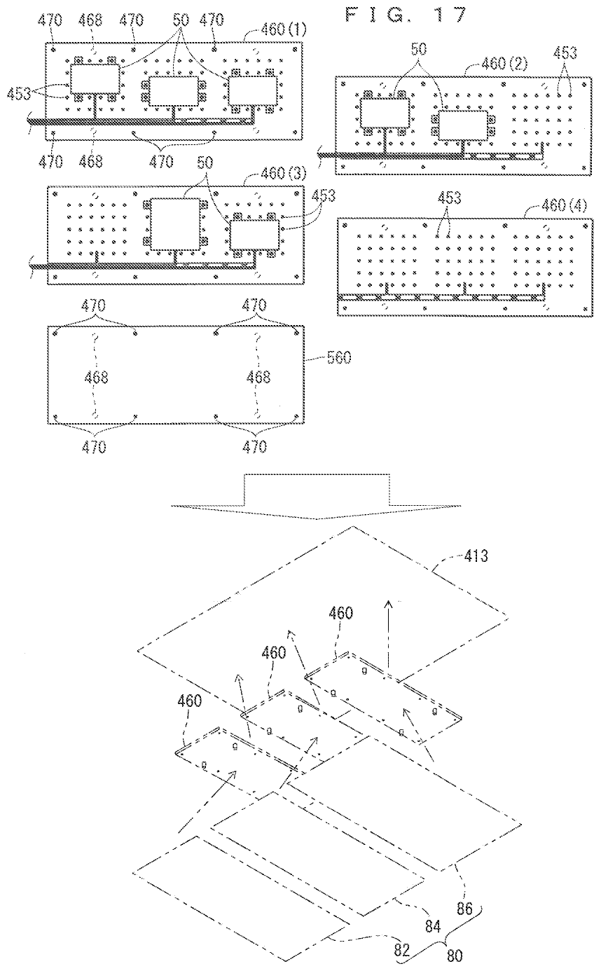

As illustrated in FIG. 17, prepared firstly are plural types of intermediate support member 460 distinguished in accordance with presence of absence of the supported roof component (particularly, the roof-side apparatus 50) and a type of the supported roof component (particularly, the roof-side apparatus 50). FIG. 17 illustrates intermediate support members 460(1), 460(2), and 460(3) in which the type of the number of the supported roof-side apparatuses 50 are different from each other as the example of the intermediate support member 460. An intermediate support member 460(4) which does not include the roof-side apparatus 50 is illustrated as the example of the intermediate support member 460. An intermediate support member 560 which does not include the roof-side apparatus 50 and further the fixing hole 453 for fixing the roof-side apparatus 50 is illustrated as the example of the intermediate support member 460.

Presence or absence and the type of the roof-side apparatus 50 to be disposed between the roof panel 413 and the roof interior member 80 are determined in accordance with a type, a grade, and presence or absence of option of the vehicle to be assembled to the roof module 21. The intermediate support member to be attached is selected from the plural types of intermediate support members 460(1), 460(2), 460(3), 460(4), and 560 in accordance with the determined presence or absence and the type of the roof-side apparatus 50. When there is a possibility that the roof-side apparatus 50 is subsequently added, the intermediate support member 460(4) is preferably selected, and when there is no possibility that the roof-side apparatus 50 is added, the intermediate support member 560 is preferably selected.

Then, the intermediate support member selected from the intermediate support members 460(1), 460(2), 460(3), 460(4), and 560 is attached to the roof panel 413.

Subsequently, the roof interior member 80 is attached to the intermediate support member selected from the intermediate support members 460(1), 460(2), 460(3), 460(4), and 560.

In this manner, such a configuration can easily deal with various combinations of the roof-side apparatus 50 by selecting the intermediate support members 460(1), 460(2), 460(3), 460(4), and 560. The intermediate support member 460(4) with no roof-side apparatus 50 or the intermediate support member 560 with no fixing bole 453 for fixing the roof-side apparatus 50 is used, thus the configuration of supporting the interior member by the intermediate support member can be achieved regardless of presence or absence of support of the roof component.

### Modification Example

Each configuration described in the embodiments and modification examples thereof can be appropriately combined as long as they are not contradictory. For example, adoptable is a configuration of position-adjustably supporting the fixing part in the embodiment 2.

### EXPLANATION OF REFERENCE SIGNS

S screw
10 vehicle
12 body
13, 413 roof panel
13a panel body
13h, 30h, 80h, 165h, 174h opening
14 roof reinforcement member
14h, 88ah, 260h fixing hole
20, 420 interior member-equipped roof module
21, 221, 421 roof module
30 sheet-like member
32 non-woven layer
34 radio wave shielding layer
40, 440 transmission member
50, 500 roof-side apparatus
60, 460, 560 intermediate support member
68, 468 interior member-side fixing part
70, 470 panel-side fixing part
80 roof interior member
81 handle
82, 84, 86 segmented roof interior member
82g, 84g inclined surface
82p, 86p, 415c concave part
82s, 86s step part
88 support bracket
88a support plate part
88b leg part
161 plate-like part
164 movable support part
164h holding hole
165 introduction part
165a guide edge
166 auxiliary plate-like part
167 hole
170, 260, 270, 415a fixing part
173 fitting body part
174, 261 head part
175 insertion part
175S slit
175e tip end portion
177 fitting state holding pin
178 pin head part
179 columnar part
179a first guide surface
179b groove part
179c second guide surface
262 cylindrical part
271 pillar part
272 elastic piece
310 positioning concave part
320 positioning convex part
413a panel body part
414 receiving part
414a end portion
414b intermediate portion
414c through hole
415 panel-side wiring bolding part
415b holding part
432, 532 fixing piece
433, 453 fixing hole
450 intermediate portion
452 apparatus fixing part
454 wiring holding part

1. An interior member-equipped roof module, comprising:
a roof interior member covering a roof panel of a vehicle from a side of a vehicle interior, and including a plurality of segmented roof interior members, the plurality of segmented roof interior members forming a continuous body continuously formed in a state of extending in different regions in the roof panel to have a shape of covering the roof panel from the side of the vehicle interior; and
at least one intermediate support member which can be attached to the roof panel, wherein
at least one of the plurality of segmented roof interior members is attached to the intermediate support member, thereby being supported by the roof panel in an attaching form, and
at least one of a roof-side apparatus and/or a transmission member disposed between the roof panel and the roof interior member is directly supported by the intermediate support member.

2. The interior member-equipped roof module according to claim 1, wherein
edges of the plurality of segmented roof interior members are overlapped with each other at a boundary.

3. (canceled)

4. (canceled)

5. The interior member-equipped roof module according to claim 1, wherein
a sheet-like member disposed between the roof panel and the roof interior member is supported by the intermediate support member in a planarly extending form.

6. The interior member-equipped roof module according to claim 1, comprising
a fixing part fixing the segmented roof interior members to the intermediate support member, wherein
at least one of the segmented roof interior members and/or the intermediate support member includes a movable support part position-adjustably supporting the fixing part in a direction in which the segmented roof interior members extend.

7. The interior member-equipped roof module according to claim 1, wherein
a positioning concave part is formed in one of the intermediate support member and the segmented roof interior members, and a positioning convex part fitted to the positioning concave part is formed in another one of the intermediate support member and the segmented roof interior members.

8. The interior member-equipped roof module according to claim 1, comprising
the plurality of intermediate support members, wherein
the boundary between the plurality of segmented roof interior members are located between the plurality of intermediate support members.

9. A roof module, comprising:
an intermediate support member disposed on a side of a vehicle interior of a roof panel of a vehicle; and
a roof component disposed between the roof panel and a roof interior member, wherein
the roof component is at least one of a roof-side apparatus and/or a transmission member,
the intermediate support member directly supports the roof component,
the intermediate support member includes a panel-side fixing part fixed to the roof panel and an interior member-side fixing part to which the roof interior member is fixed, and
the intermediate support member supports the roof interior member fixed to the interior member-side fixing part while the roof interior member is attached to the roof panel.

10. A method of manufacturing an interior member-equipped roof module comprising:
(a) preparing plural types of intermediate support members distinguished in accordance with presence or absence of support of a roof component and a type of the roof component which is supported;
(b) selecting an intermediate support member, which is to be attached, from the plural types of intermediate support members in accordance with presence or absence and a type of a roof component disposed between a roof panel and a roof interior member;
(c) attaching the intermediate support member which has been selected to the roof panel; and
(d) attaching a roof interior member to the intermediate support member so that the roof interior member is supported by the intermediate support member while being attached to the roof panel.
